(19) United States
(12) Patent Application Publication
(10) Pub. No.: US 2023/0401699 A1
(43) Pub. Date: Dec. 14, 2023

(54) DETECTION OF SPINE VERTEBRAE IN IMAGE DATA

(71) Applicant: KONINKLIJKE PHILIPS N.V., EINDHOVEN (NL)

(72) Inventors: Amir YAAKOBI, RA'ANANA (IL); Ohad SILBERT, RA'ANANA (IL); Guy ENGELHARD, RA'ANANA (IL)

(21) Appl. No.: 18/033,434

(22) PCT Filed: Oct. 25, 2021
(86) PCT No.: PCT/EP2021/079444

§ 371 Date: Apr. 24, 2023

Related U.S. Application Data
(60) Provisional application No. 63/106,055, filed on Oct. 27, 2020.

(51) Int. Cl. G06T 7/00

(52) U.S. Cl. CPC G06T 7/0012; G06T 2207/30012; G06T 2207/20084

(57) ABSTRACT

Vertebrae of the spine in volumetric image are detected using multi-stage detection with trained artificial intelligence. In one embodiment, a trained neural network (116) is employed in a first stage to detect individual vertebra in sagittal images. Two-dimensional bounding boxes around the detected vertebrae are combined to generate a three-dimensional model of the spine. A panoramic image of the spine is generated based on the three-dimensional model to create a straightened view of the spine. The trained neural network is employed in a second stage to detect individual vertebra in the panoramic image. Two-dimensional bounding boxes around the detected vertebrae in the panoramic image are translated to three-dimensional space to create three-dimensional image data with three-dimensional bounding boxes.

### FIELD

The following generally relates to medical imaging informatics and more particularly to detection of spine vertebrae in image data.

### BACKGROUND

When a radiologist reads an axial spine image that has not been annotated with the identification of the vertebrae, it is difficult for the radiologist to ascertain which vertebra is represented in the axial spine image without referring to a sagittal spine and/or other image to cross-reference the location of the axial spine image with respect to the spine. In one instance, the radiologist is tasked with manually annotating and/or counting vertebra centers. Unfortunately, this is tedious, time consuming and prone to human error. Automated vertebrae detection algorithms are described in Payer et al., “Vertebrae Localization and Segmentation with SpatialConfiguration-Net and U-Net,” (2019), and Chen, “An Automatic Multi-stage System for Vertebra Segmentation and Labelling, (2019), and Lessmann et al., “Iterative fully convolutional neural networks,” (2019). Unfortunately, these approaches require significant computing power. In view of at least the above, there is an unresolved need for another approach(s) for detecting and labelling spine vertebrae in volumetric image data.

### SUMMARY

Aspects described herein address the above-referenced problems and/or others.

The following describes a multi-stage approach for automated detection and labelling of spine vertebrae in volumetric image data. In one embodiment, an object detection algorithm is used in a first detection stage to detect individual vertebra in sagittal images and generate 2-D bounding boxes for the detected vertebrae. The sagittal images and the 2-D bounding boxes are combined to generate a 3-D model of the spine with 3-D bounding boxes. A panoramic image of the spine is then generated based on the 3-D model to create a straightened view of the spine. The object detection algorithm (or another algorithm) is used in a second stage to detect individual vertebra in the panoramic image and generate 2-D bounding boxes for the detected vertebrae. The 2-D bounding boxes for the vertebrae in the panoramic image are translated to 3-D space.

In one aspect, a system is configured to detect vertebrae of a spine in volumetric image data. The system includes a computing apparatus. The computing apparatus includes memory with instructions for a vertebrae detection module. The computing apparatus further includes a processor configured to execute the instructions to perform a two-stage vertebrae detection in which a first set of bounding boxes for the vertebrae are detected in sagittal images and clustered into boxes in the volumetric image in a first stage of the two stage vertebrae detection, a panoramic image of the spine is generated based on the detected first set of bounding boxes, and a second set of bounding boxes for the vertebrae are detected in the panoramic image in a second stage of the two stage vertebrae detection. The computing apparatus further includes a display configured to display a 2-D image of a detected vertebra. In one instance, all the detected bounding boxes, both the first set and the second set, are labeled either as Sacrum, C2 or “other” vertebra. This is at least because both C2 and the Sacrum vertebra have a unique shape and serve as anchors for the annotation of the vertebra after the detection of the bounding boxes.

In another aspect, a method is configured for detecting vertebrae of a spine in volumetric image data. The method includes extracting a first set of bounding boxes for vertebrae in sagittal images of the spine, and, in one instance, labeling them either as Sacrum, C2 or “other” vertebra. The method then includes clustering of the bounding boxes of the sagittal images into boxes in the volumetric image. The method further includes generating a panoramic image of the spine based on the detected first set of bounding boxes. The method further includes extracting a second set of bounding boxes for the vertebrae in the panoramic image, with the same labeling as before.

In another aspect, a computer-readable storage medium stores instructions for detecting vertebrae of a spine in volumetric image data. The instructions, when executed by a processor of a computer, cause the processor to extract a first set of bounding boxes for vertebrae in sagittal images of the spine, and, in one instance, labeling them either as Sacrum, C2 or “other” vertebra, cluster them into boxes in the volumetric data, generate a panoramic image of the spine based on the detected first set of volumetric bounding boxes, and extract a second set of bounding boxes for the vertebrae in the panoramic image.

Those skilled in the art will recognize still other aspects of the present application upon reading and understanding the attached description.

### BRIEF DESCRIPTION OF THE DRAWINGS

The invention may take form in various components and arrangements of components, and in various steps and arrangements of steps. The drawings are only for purposes of illustrating the embodiments and are not to be construed as limiting the invention.

FIG. 1 diagrammatically illustrates an example system with a vertebrae detection and labelling module that is configured to detect and label vertebrae of a spine in volumetric image data, in accordance with an embodiment(s) herein.

FIG. 2 diagrammatically illustrates an example of the vertebrae detection and labelling module of the system of FIG. 1, in accordance with an embodiment(s) herein.

FIG. 3 diagrammatically illustrates example method for detecting and labelling vertebrae of a spine in volumetric image data, in accordance with an embodiment(s) herein.

### DESCRIPTION OF EMBODIMENTS

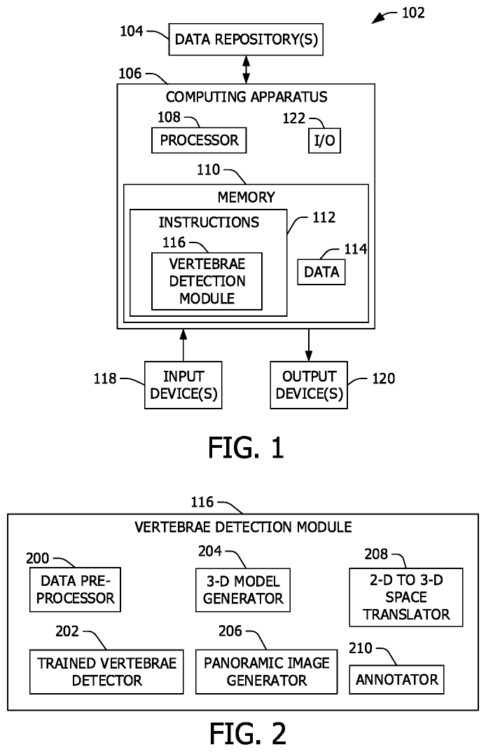

FIG. 1 diagrammatically illustrates an example system 102, in accordance with an embodiment(s) herein. The system 102 includes at least a data repository(s) 104 and a computing apparatus 106.

The data repository(s) 104 includes a physical storage medium configured to store at least digital medical images. In one instance, the data repository(s) 104 is for a healthcare entity(s) and/or the like and includes digital medical images of subjects acquired by imaging modalities of the healthcare entity(s). The physical storage medium is local to the healthcare entity and/or remote therefrom such as part of “cloud” based resources. Examples of imaging modalities include magnetic resonance (MR), computed tomography (CT), single photon emission tomography (SPECT), positron emission tomography (PET), X-ray, etc. The digital medical images include series of two-dimensional (2-D) images (which collectively provide a three-dimensional (3-D) volumetric image dataset) and/or a 3-D volumetric image dataset. The digital medical images at least include images of vertebrae of the spine of a subject.

The computing apparatus 106 includes a processor 108 (e.g., a central processing unit (CPU), a microprocessor (CPU), graphics processing unit (GPU), and/or other processor) and computer readable storage medium (“memory”) 110 (which excludes transitory medium), such as a physical storage device like a hard disk drive, a solid-state drive, an optical disk, and/or the like. The memory 110 includes at least computer executable instructions 112 and data 114. The processor 108 is configured to execute the computer executable instructions 112. In one instance, the computing system 106 is configured to provide storage of, access to and/or processing for medical information including digital medical images, electronic reports, etc. An example of the computing apparatus 106 includes, but is not limited to, a picture archiving and communication system (PACS). Where the computing system 106 is a PACS, digital medical images and/or other electronic information are stored and/or transferred to and from via the DICOM (Digital Imaging and Communications in Medicine) format and/or another format(s).

The instructions 112 includes instructions at least for a vertebrae detection module 116. As described in greater detail below, in one embodiment, the vertebrae detection module 116 is configured to detect individual vertebra in images of the spine acquired in the sagittal plane (“sagittal images”) and generate 2-D bounding boxes for the detected vertebrae, combine the sagittal images and the 2-D bounding boxes to generate a 3-D model of the spine with 3-D bounding boxes, generate a panoramic image of the detected vertebrae based on the 3-D model to create a straightened view of the spine, detect the individual vertebra in the panoramic image and generate 2-D bounding boxes for the detected vertebrae in the panoramic image, translate the 2-D bounding boxes to 3-D space, and, optionally, annotate a displayed 2-D image. As utilized herein, a bounding box bounds or encloses a vertebra, with or without partial overlap of one or more neighboring vertebrae. In one instance, the vertebrae detection module 116 reduces computing power for detection and labelling and/or improves an accuracy of vertebrae delineation, relative to a configuration without the vertebrae detection module 116.

An input device(s) 118, such as a keyboard, mouse, a touchscreen, etc., is in electrical communication with the computing system 102. In one instance, the input device(s) 118 is configured to allow a user to operate the computing system 102 via user input, including activating the vertebrae detection module 116, selecting volumetric image data and/or sagittal images to load, etc. A human readable output device(s) 120, such as a display, is also in electrical communication with the computing apparatus 106. In one instance, the output device(s) 120 is configured to display a 2-D image of a vertebra, prompt a user for input, present instructions, etc. Input/output (“I/O”) 122 is configured for communication (wire and/or wireless) with at least the data repository(s) 104, including retrieving/receiving electronic data from and/or conveying data to the data repository(s) 104, the input device(s) 118 and/or the output device(s) 120.

FIG. 2 diagrammatically illustrates an example of the vertebrae detection module 116, in accordance with an embodiment(s) herein. The illustrated vertebrae detection module 116 includes a data pre-processor 200, a trained vertebrae detector 202, a 3-D model generator 204, a panoramic image generator 206, a 2-D to 3-D space translator 208, and an annotator 210.

The vertebrae detection module 116 receives, as input, image data of a spine scan of a subject, including a series of 2-D images (which collectively provide a 3-D volumetric dataset) and/or a 3-D volumetric dataset, or one or more sets of sagittal images generated from a series of 2-D images (which collectively provide a 3-D volumetric dataset) and/or a 3-D volumetric dataset. As discussed briefly herein, suitable datasets include MR, CT, SPECT, PET, X-ray, etc. In one instance, the particular image data is selected via a user input from the input device(s) 118.

The data pre-processor 200 is configured to process the input image data. In one instance, a result of the processing is one or more sets of sagittal slices. Parameters such as window width, window level, slice thickness, etc. are determined via user input and/or pre-programmed settings. Where multiple sets of sagittal slices are generated, in one instance, the window width, window level, and/or other parameter is the same for all of the slices. In another instance, at least two of the sets have at least one different parameter value. Window width refers to the range of CT numbers (in Hounsfield units (HU)) to display, and window level refers to the CT number at the midpoint of the range. An example of window width and level (W/L) settings for viewing the spine in an image that includes the spine is: W=1800 HU and L=400 HU. Where the input image data includes the one or more sets of sagittal images, the data pre-processor 200 is not utilized to process the input image data to create the one or more sets of sagittal images.

The trained vertebrae detector 202 is configured to process the one or more sets of sagittal slices. In one instance, this includes detecting whether a slice includes a vertebra and generating a 2-D bounding box for the detected vertebra. In one instance, the vertebra detection begins at a center slice and proceeds slice-by-slice in both directions to the outermost slices, i.e., a first and a last slice of the sagittal slices. The vertebra detection ends after all the slices have been processed, after predetermined stopping criteria is satisfied (e.g., after a pre-determined number of consecutive slices are processed without indicia of a vertebra, which indicates the spine is out of the data set), or other predetermined stopping criteria. In one instance, the predetermined stopping criteria reduces processing time, e.g., by limiting the number of slices processed.

Examples of suitable detectors include artificial intelligence based detectors, including neural network based detectors such as the faster region convolutional neural network described in Girshick et al., “Faster R-CNN: Towards Real-Time Object Detection with Region Proposal Networks,” 2015, the You Only Look Once described in Redmon et al., “YOLOv3: An Incremental Improvement,” 2018, and/or other detector(s). For sake of brevity and explanatory purposes, vertebra detection is described herein with a YOLOv3 detector. With a YOLOv3 detector, a neural network is applied to the image, the image is divided into regions, and bounding boxes and probabilities are predicted for each region, where the bounding boxes are weighted by the predicted probabilities.

With a YOLOv3 detector, a predetermined minimum confidence threshold is utilized to determine whether to generate a 2-D bounding box for an object detected as possibly a vertebra. In one instance, the minimum confidence threshold is 0.55. This means that 2-D bounding boxes will only be generated for vertebra detected with a confidence of 0.55 or higher. In another instance, the minimum confidence threshold is 0.50. In yet another instance, the minimum confidence threshold is a different value. A minimum confidence threshold of 0 will result in generating a 2-D bounding box for every object detected as possibly a vertebra. In general, a higher threshold improves specificity, whereas a lower threshold improves sensitivity.

The 3-D model generator 204 is configured to process the one or more sets of sagittal images and the 2-D bounding boxes. In one instance, this includes combining the 2-D bounding boxes across the sagittal slices to generate a 3-D model with 3-D bounding boxes for each detected vertebra. For sake of brevity and explanatory purposes, this is described herein using the density-based spatial clustering of applications with noise (DBSCAN) algorithm described in Ester et al., “A density-based algorithm for discovering clusters in large spatial databases with noise. Proceedings of the Second International Conference on Knowledge Discovery and Data Mining (KDD-96),” AAAI Press. pp. 226-231. DBSCAN is a density-based data clustering non-parametric algorithm, where, given a set of points in some space, points that are close to each other are clustered/grouped together, and points whose nearest neighbors are far away are considered outliers.

The panoramic image generator 206 is configured to process the 3-D model and the 3-D bounding boxes. In one instance, this includes generating a panoramic image using a curve through centers of the 3D bounding boxes. In one instance, the curve is extrapolated before the first vertebra and after the last vertebra. This allows the panoramic image generator 206 to add a vertebra(s) missing at the edges. The curve is interpolated and sampled at a pre-determined interval (e.g., 0.1, 0.5, 1.0, 2.5, etc. millimeters (mm)). For each point on the curve, a line from the 3-D model is sampled along the projection of a vector that goes from one side of the body to an opposing side, such as from a front of the body to a back of the body, onto a plane perpendicular to the curve at that point. The result is a panoramic (quasi-sagittal) image which contains the whole spine aligned vertically.

The trained vertebrae detector 202 is further configured to process the panoramic image. In one instance, this includes detecting vertebrae in the panoramic image and generating a 2-D bounding box around each detected vertebra. In one instance, the minimum confidence threshold is 0.50. Similar to the detection in the sagittal slices, the minimum confidence threshold can be a different value. In general, vertebra detection in the panoramic image should be more accurate than the detection with the sagittal slices at least since the spine is straightened and entirely displayed and any vertebrae missed using the sagittal images are now detected here. In one instance, this improves sensitivity without reducing specificity. In another embodiment, separate vertebrae detectors are utilized for detector vertebrae in the sagittal images and the panoramic image.

The 2-D to 3-D space translator 208 is configured to process the panoramic image having the 2-D bounding boxes. In one instance, this includes translating the 2-D bounding boxes to 3-D space and adding depth to each bounding box. For example, in one instance each corner of each bounding box is translated to 3-D space, and the bounding box of all four corners is set as the bounding box of the vertebra, where depth is set to be the same as the smaller edge of the 2-D bounding box, i.e. the smaller of the width or the height of the bounding box.

The trained vertebrae detector 202 is further configured to determine an identification of at least a sub-set of the identified vertebrae. For example, in one instance the trained vertebrae detector 202 identifies at least one cervical spine vertebra, multiple sacrum vertebrae and the other spine vertebrae, such as C2, S1, S2, S3, S4, S5, and another symbol or words for all the other vertebrae. Vertebrae other than C2 and S1-S5 (i.e. C3-C7, T1-T12, L1-L5, and/or the coccyx vertebrae) can be identified by counting back or forward from a reference identified vertebra. In another instance, a different combination of a sub-set of vertebrae is identified (e.g., C2, Sacrum, and other vertebra), only one vertebra is identified, or all of the vertebrae are identified.

The annotator 210 is configured to annotate a displayed 2-D image of the input volumetric image data. In one instance, the annotation is a projection of a center of a bounding box onto a current slice. By way of non-limiting example, in an axial slice that is off center, the annotator 210 projects the center from the central axial slice. Alternatively, or additionally, the annotator marks the intersection of the center line passing through the vertebra with the current plane. In another instance, the detected vertebrae are annotated by displaying vertebra labels next to each vertebra without any bounding box or center projection.

Variations are contemplated next.

In a variation, the entire algorithm is ran iteratively. For this, the sagittal slices are processed, bounding boxes are found, a 3-D model is generated, a panoramic image is generated, bounding boxes are determined for the panoramic image, the bounding boxes are translated to 3-D space, and the process is repeated until stopping criteria is satisfied.

In the above, the trained vertebrae detector 202 detects vertebrae in the sagittal images and the panoramic image. In a variation, separate trained vertebrae detectors respectively detect vertebrae in the sagittal images and the panoramic image.

The following describes a non-limiting example for training a vertebrae detector to create the trained vertebrae detector 202 for a single imaging modality. For sake of brevity and explanatory purposes, the training is described using CT. Sagittal images of the lumbar spine, thoracic spine and cervical spine for CT studies are annotated. All of the sagittal images are sampled in a same predetermined resolution with a same predetermined fixed spacing. For example, in one instance the sagittal images are sampled in a resolution of 416×416 with a pixel spacing of 1 mm. For a larger image, the image is divided into multiple regions and each region is sampled to cover all of the image.

The sagittal images with the 2-D bounding boxes are fed into training. The sagittal images with the 2-D bounding boxes are also augmented to produce additional training data. Examples of features that are augmented include one or more of the following: brightness, contrast, Gaussian noise, shift, scale, rotate and flip. For each feature, a probability of augmentation and an augmentation limit is predetermined. For instance, a probability 0.80 and an augmentation limit of 0.03 for brightness would result in the brightness being augmented in 80% of the images in a range of ±3% of the original value. Augmenting the sagittal images as such increases a diversity in the data and/or mitigates over-fitting—memorization of the training data.

The training datasets are divided into training, testing, and validating subsets of a predetermined size. The CT training dataset is used to train the trained vertebrae detector 202 for vertebrae detection in CT image data. With a YOLOv3 based network, the vertebrae detector is iteratively trained until stopping criteria is satisfied. In one instance, the vertebrae detector is iteratively trained until an error between the original bounding boxes and the generated bounding boxes satisfies a predetermined value. The vertebrae detector is trained to detect all or a subset of the vertebrae.

In one instance, a validation data set is used during training to determine the stopping criteria. In this instance, the network weights are not affected by the validation stage, and a quality of the training is determined by examining metrics. For example, once training terminates, the network is ran on the test data set and metrics therefore are compared with metrics for the validation data set. If the metrics deviate within a predetermined tolerance, the training is considered effective and terminates.

Variations for training are contemplated next.

In a variation, the training images also include panoramic images that are based on the annotated vertebra centers and have the same resolution and pixel spacing. The feature augmentations may be different between the sagittal images and the panoramic images, e.g., panoramic images do not have shift and rotate augmentations.

In another variation, the vertebrae detector is trained for multiple imaging modalities. For sake of brevity and explanatory purposes, the training is described using CT and MR image data. With this variation, augmentation may vary across modality, e.g., the contrast limit for CT may be 0.30 whereas the contrast limit for MR may be 0.40. In one variation, the CT and MR datasets are used to train separate vertebrae detectors respectively to detect vertebrae in CT images and MR images. In another variation, the CT and MR datasets are used to train a CT+MR vertebrae detector for vertebrae detection in CT or MR image data.

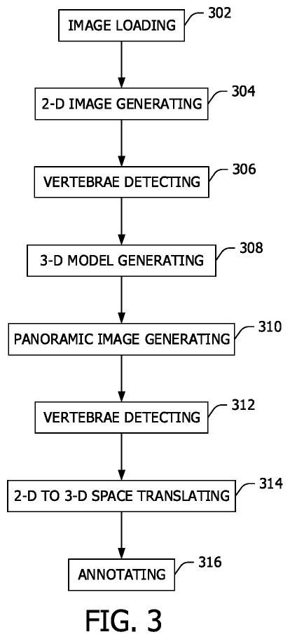

FIG. 3 diagrammatically illustrates an example method for detecting and labelling vertebrae of a spine in volumetric image data, in accordance with an embodiment(s) herein.

It is to be appreciated that the ordering of the acts of one or more of the method is not limiting. As such, other orderings are contemplated herein. In addition, one or more acts may be omitted, and/or one or more additional acts may be included.

An image loading step 302 loads volumetric image data, as described herein and/or otherwise.

A 2-D image generating step 304 generates one or more sets of sagittal images from the volumetric image data, as described herein and/or otherwise.

Alternatively, the loading step loads the one or more sets of sagittal images and step 304 is omitted, as described herein and/or otherwise.

A vertebrae detecting step 306 detects vertebrae in the one or more sets of sagittal images and generates 2-D bounding boxes therefor, as described herein and/or otherwise.

A 3-D model generating step 308 generates a 3-D model of the spine with 3-D bounding boxes from the sagittal images and 2-D bounding boxes, as described herein and/or otherwise.

A panoramic image generating step 310 generates a panoramic image based on the 3-D model, as described herein and/or otherwise.

A vertebrae detecting step 312 detects vertebrae in the panoramic image and generates 2-D bounding boxes therefor, as described herein and/or otherwise.

A 2-D to 3-D translating step 314 translates the 2-D bounding boxes for the vertebrae in the panoramic image to 3-D space, as described herein and/or otherwise.

An annotating step 316 annotates a displayed 2-D image of the volumetric image data, as described herein and/or otherwise.

The above methods can be implemented by way of computer readable instructions, encoded, or embedded on the computer readable storage medium 110, which, when executed by a computer processor(s), cause the processor(s) 108 to carry out the described acts. Additionally, or alternatively, at least one of the computer readable instructions is carried out by a signal, carrier wave or other transitory medium, which is not computer readable storage medium.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

The word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A system configured to detect vertebrae of a spine in volumetric image data, comprising:
a computing apparatus, comprising:
a memory including instructions for a vertebrae detection module;
a processor configured to execute the instructions to perform a two stage vertebrae detection in which a first set of bounding boxes for the vertebrae are detected in sagittal images and clustered in the volumetric image data in a first stage of the two stage vertebrae detection, a panoramic image of the spine is generated based on the detected first set of bounding boxes, and a second set of bounding boxes for the vertebrae are detected in the panoramic image in a second stage of the two stage vertebrae detection; and
a display configured to display a 2-D image from the volumetric image data of a detected vertebra.

2. The system of claim 1, wherein the vertebrae detection module includes a neural network trained to detect vertebrae.

3. The system of claim 1, wherein the vertebrae detection module detects the first set of bounding boxes based on a first predetermined confidence level and generates 2-D bounding boxes for detected vertebrae.

4. The system of claim 1, wherein the vertebrae detection module detects the first set of bounding boxes beginning with a central image of the sagittal images and moving outwards in both directions towards a first image of the sagittal images and a last image of the sagittal images until stopping criteria is satisfied.

5. The system of claim 4, wherein the stopping criteria includes a predetermined number of consecutive images of the sagittal images in which no vertebra is detected.

6. The system of claim 3, wherein the vertebrae detection module labels each vertebra of the first set of bounding boxes as Sacrum, C2 or other vertebra.

7. The system of claim 3, wherein the vertebrae detection module combines the sagittal images and the 2-D bounding boxes to generate a 3-D model with 3-D bounding boxes.

8. The system of claim 7, wherein the vertebrae detection module generates a curve through centers of the 3-D bounding boxes.

9. The system of claim 8, where the vertebrae detection module extrapolates the curve before a first vertebra and after a last vertebra to add missing vertebrae.

10. The system of claim 8, where the vertebrae detection module, for each point on the curve, samples a line from the 3-D model along a projection of a vector which goes from a front of the spine to a back of the spine onto a plane perpendicular to the curve at that point to produce the panoramic image, which includes a quasi-sagittal image that contains the whole spine aligned vertically.

11. The system of claim 10, wherein the vertebrae detection module detects the second set of bounding boxes based on a second predetermined confidence level and generates 2-D bounding boxes for the detected vertebrae.

12. The system of claim 11, where the vertebrae detection module translates the 2-D bounding boxes for the panoramic image to 3-D space to define 3-D bounding boxes for the vertebrae.

13. The system of claim 11, wherein the vertebrae detection module labels each vertebra of the second set of bounding boxes as Sacrum, C2 or other vertebra.

14. The system of claim 1, where the computing apparatus is a picture archiving communication system.

15. A computer-implemented method for detecting vertebrae of a spine in volumetric image data, comprising:
extracting a first set of bounding boxes for vertebrae in sagittal images of the spine;
generating a panoramic image of the spine based on the detected first set of bounding boxes; and
extracting a second set of bounding boxes for the vertebrae in the panoramic image.

16. The computer-implemented method of claim 15, wherein extracting the first set of bounding boxes includes:
detecting the first set of bounding boxes beginning with a center image of the sagittal images and moving outward to a first image of the sagittal images and a last image of the sagittal images; and
terminating detection in response to a predetermined number of consecutive sagittal images having no vertebra;
generating 2-D bounding boxes for the detected vertebrae;
identifying centers of the 2-D bounding boxes; and
annotating the vertebrae of the 2-D bounding boxes.

17. The computer-implemented method of claim 15, further comprising:
detecting the second set of 2-D bounding boxes in the panoramic image based on a second predetermined confidence level; and
translating the 2-D bounding boxes in the panoramic image to 3-D space to define 3-D bounding boxes for the vertebrae; and
annotating the vertebrae of the 3-D bounding boxes.

18. A computer-readable storage medium storing computer executable instructions, for detecting vertebrae of a spine in volumetric image data, which when executed by a processor of a computer cause the processor to:
extract a first set of bounding boxes for vertebrae in sagittal images of the spine;
generate a panoramic image of the spine based on the detected first set of bounding boxes; and
extract a second set of bounding boxes for the vertebrae in the panoramic image.

19. The computer-readable storage medium of claim 18, wherein the computer executable instructions further cause the processor to:
detect the first set of bounding boxes beginning with a center image of the sagittal images and moving outward to a first image of the sagittal images and a last image of the sagittal images;
terminate detection in response to a predetermined number of consecutive sagittal images having no vertebra;
generate 2-D bounding boxes for the detected vertebrae;
identify centers of the 2-D bounding boxes; and
annotate the vertebrae of the 2-D bounding boxes.

20. The computer-readable storage medium of claim 18, wherein the computer executable instructions further cause the processor to:
detect the second set of 2-D bounding boxes in the panoramic image based on a second predetermined confidence level;
translate the 2-D bounding boxes in the panoramic image to 3-D space to define 3-D bounding boxes for the vertebrae; and
annotate the vertebrae of the 3-D bounding boxes.
